(19) United States
(12) Patent Application Publication
(10) Pub. No.: US 2002/0052883 A1
(43) Pub. Date: May 2, 2002

(54) Online user interactive methods for designing sandwich composite and single skin composite components

(76) Inventor: Deborah Weissman-Berman, North Fort Myers, FL (US)

Correspondence Address: Daniel S. Polley, Esq., Malin, Haley & DiMaggio, P.A., 1936 South Andrews Avenue, Fort Lauderdale, FL, 33316, US

(21) Appl. No.: 09/943,865

(22) Filed: Aug. 31, 2001

Related U.S. Application Data
(60) Provisional application No. 60/230,109, filed on Sep. 5, 2000.

(51) Int. Cl. G09G 5/00; G06F 7/00; G06F 17/00

(52) U.S. Cl. 707/104.1; 345/700

(57) ABSTRACT

Disclosed is a user interactive method and website, eSOLUTIONS, for predicting the response of sandwich composite structures and single skin structures. The interactive user is able to predict the response of structures, such as sandwich composite structures and single skin composites, based on dimensions and measurements entered by the user. The present invention provides a unique forum for engineering analysis and communication through the medium of the Internet. The website can also provide access to the methods of analysis and information from scientific publishers, materials manufacturing companies, sandwich core manufacturers, etc. available on the Internet.

This application claims the benefit of and priority to U.S. Provisional Application No. 60/230,109, filed Sep. 5, 2000.

### BACKGROUND OF THE INVENTION

1. Field of the Invention

This invention relates generally to designing sandwich composite and single skin composite structures and particularly to an online user interactive method for predicting the response of sandwich composite structures and single skin composite components.

2. Description of the Prior Art

It is desired in the engineering design industry to provide a user interactive method for predicting the response of structures, such as sandwich composite structures and single skin composites, based on dimensions and physical geometric and material values entered by the user. It is also desired to provide these user services in a unique forum for engineering analysis and communication through the medium of the Internet.

It is therefore, to the effective resolution of the aforementioned problems and shortcomings of the prior art that the present invention is directed.

### SUMMARY OF THE INVENTION

The present invention provides a user interactive method, eSOLUTIONS, for predicting the response of sandwich composite structures and single skin structures. Use of the present invention allows the interactive user to predict the response of structures, such as sandwich composite structures and single skin composites, based on dimensions and measurements entered by the user. The present invention provides a unique forum for engineering analysis and communication through the medium of the Internet. The website can also provide access to the methods of analysis and information from scientific publishers, materials manufacturing companies, sandwich core manufacturers, etc. available on the Internet.

Accordingly, it is an object of the present invention to provide a user interactive method for predicting the response of sandwich composite structures and single skin composite structures.

It is another object of the present invention to provide a user interactive method for predicting the response of sandwich composite structures and single skin composite structures accessible through the Internet.

It is also another object of the present invention to provide a website which provides for the simultaneous transmission of input, output and solutions (help) in the form of text, drawings, videos and live interactive video for engineering an other application services, which are preferably, though not limiting, always available on the same calculation page.

In accordance with these and other objects which will become apparent hereinafter, the instant invention, eSOLUTIONS, will now be described with particular reference to the accompanying drawings.

### BRIEF DESCRIPTION OF THE DRAWINGS

This invention may be better understood by reference to the drawings in which:

FIG. 1 is a flowchart of the online interactive steps performed by the user in accordance with the present invention;

FIGS. 2 through 12 illustrate various website pages/screens in accordance with the present invention;

FIG. 13 indicates potential website links; and

FIG. 14 illustrates additional applications.

### DESCRIPTION OF THE PREFERRED EMBODIMENTS

As illustrated the present invention provides online user interactive methods for designing sandwich composite and single skin composite components. The user from his or her remote computer communicates with a website preferably residing on the world wide web.

As seen in the Figures from a website page, the user/client/viewer (collectively referred to as “user”) can access various modules including such as Coredes plates, Coredes, on line consulting, distance learning, ALPHA Eqns Predicted Compared to Database, Lab Data Analysis, and CoreQual QA/QC Reliability Life Cycle. The modules, including the Coredes modules are preferably all presented within the framework of a similar style sheet. The user preferably sees a screen having the title of the program and buttons to indicate the type of analysis desired on a floating input frame on the main screen.

The next portion of the same page contains the eSOLUTIONS text box and drawing area, preferably to the right, which can provide explanatory photos, drawings, streaming audio, streaming video, and/or other information mediums. A further portion of the page contains input boxes, preferably three, for the input parameter, the measurement system and the actual input data. A calculate button can be provided, preferably in the center of the page, along with an area for displaying the output data.

The present invention provides for the simultaneous transmission of input, output and solutions (methodology and explanation of terms) in the form of text, drawings, videos and live interactive video for engineering an other application services, which are preferably, though not limiting, always available on the same calculation page. The solutions are preferably an integral/visible part of the workspace for immediate use by the user/viewer without having to transfer to a different page.

The organization of the calculation page provides a single view access to multiple solutions of the same problem. These solutions can be in the form of, but not limited to, equations, explanation of terms, physical and material databases, publications, instructions, historical databases, real-time consulting solutions, other forms of informative text, graphs, charts, illustrations, photographs, digitized representations of the process, and/or streaming videos. The synchronous access to “multiple” databases are preferably embedded into a one-view access.

Use of the present invention allows the interactive user to predict the response of structures, such as sandwich composite structures and single skin composites, based on dimensions and physical geometric and material values entered by the user. The present invention provides a unique forum for engineering analysis and communication through the medium of the Internet. The website can provide access to the methods of analysis and information from scientific publishers, materials manufacturing companies, sandwich core manufacturers, etc. available on the Internet.

The user interactive website can be accessible through desktop computers, laptops, handheld computers, through wireless applications, etc.

The present invention can be used by all types of individuals, including, but not limited to, designers and engineers in the marine field, aerospace, building and construction industries and in designing components for automobiles, including RVs. Some specific uses include, but are not limited to, identifying and characterizing injected sandwich products with thermoplastic skin for the building and construction trade; determining the response of thermoset and thermoplastic sandwich panels to high strain rate of input load for use in marine, transportation, aircraft and aerospace industries.

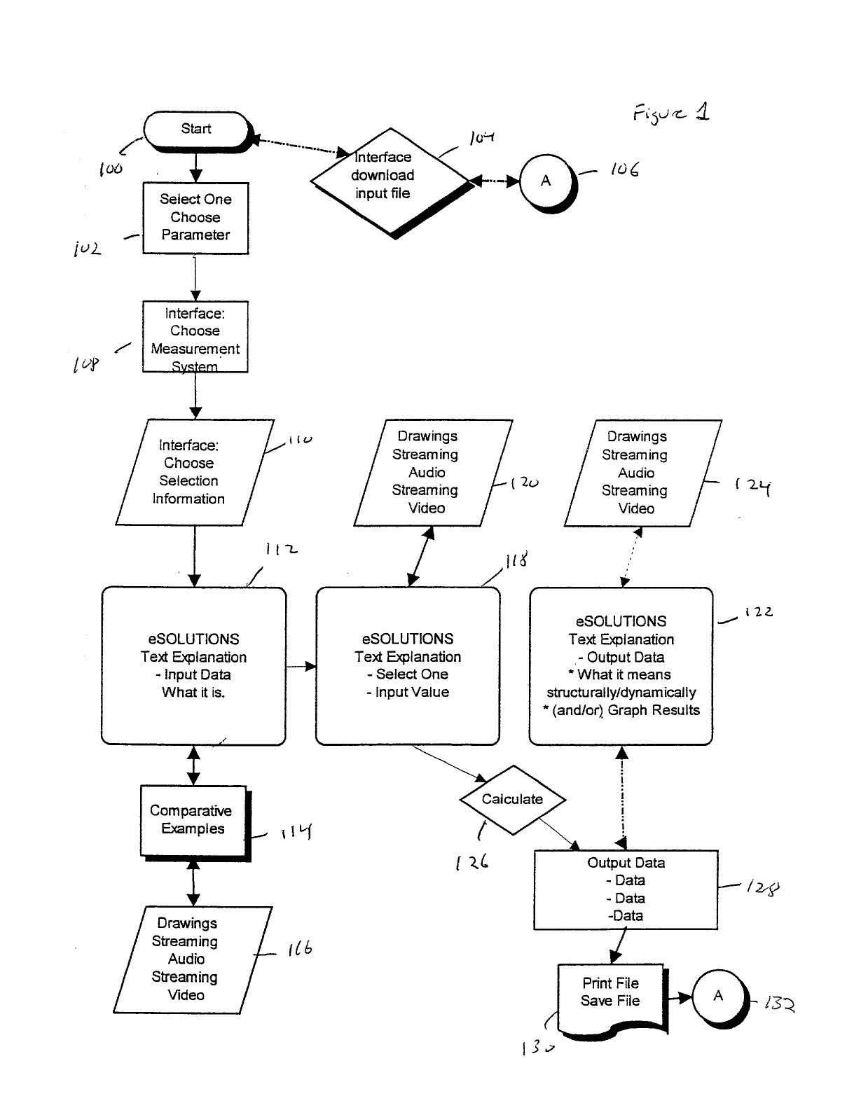

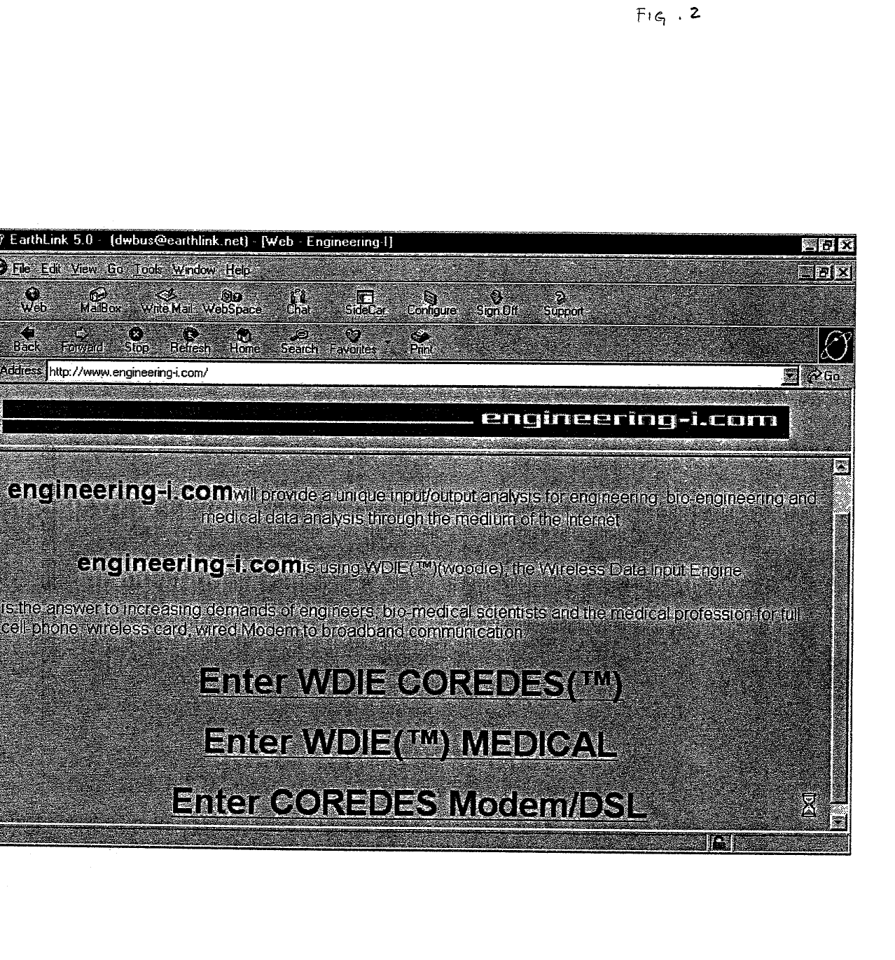

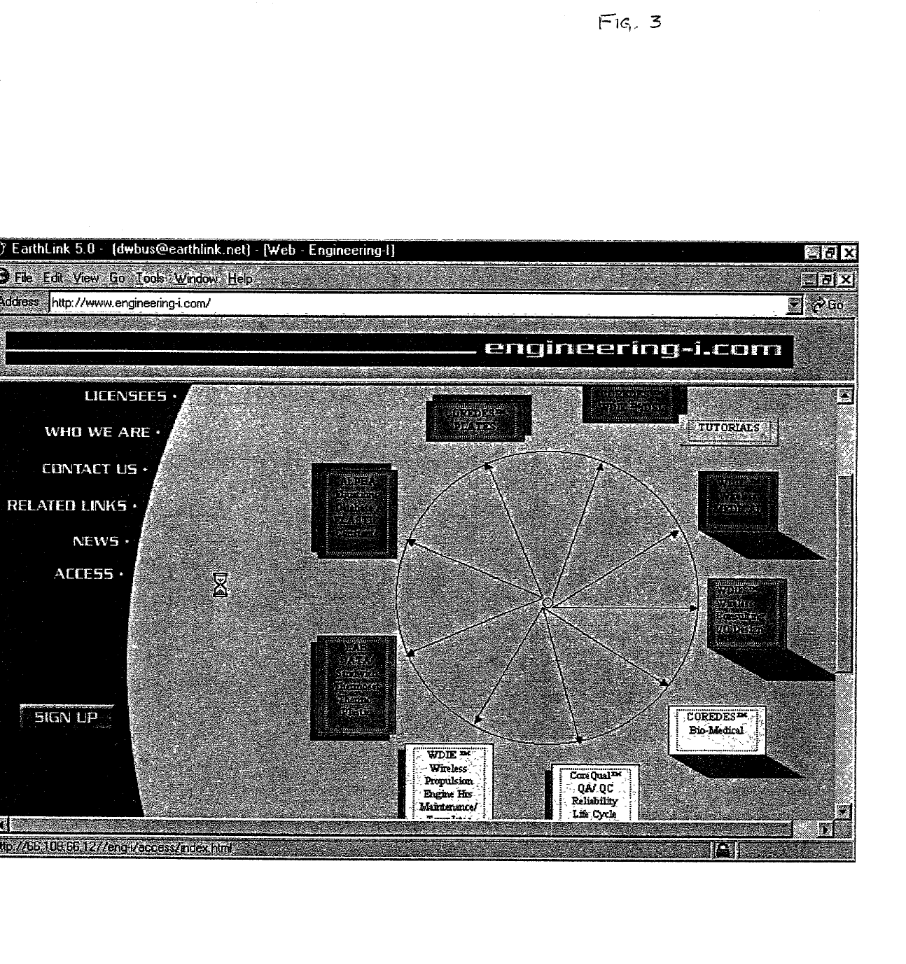

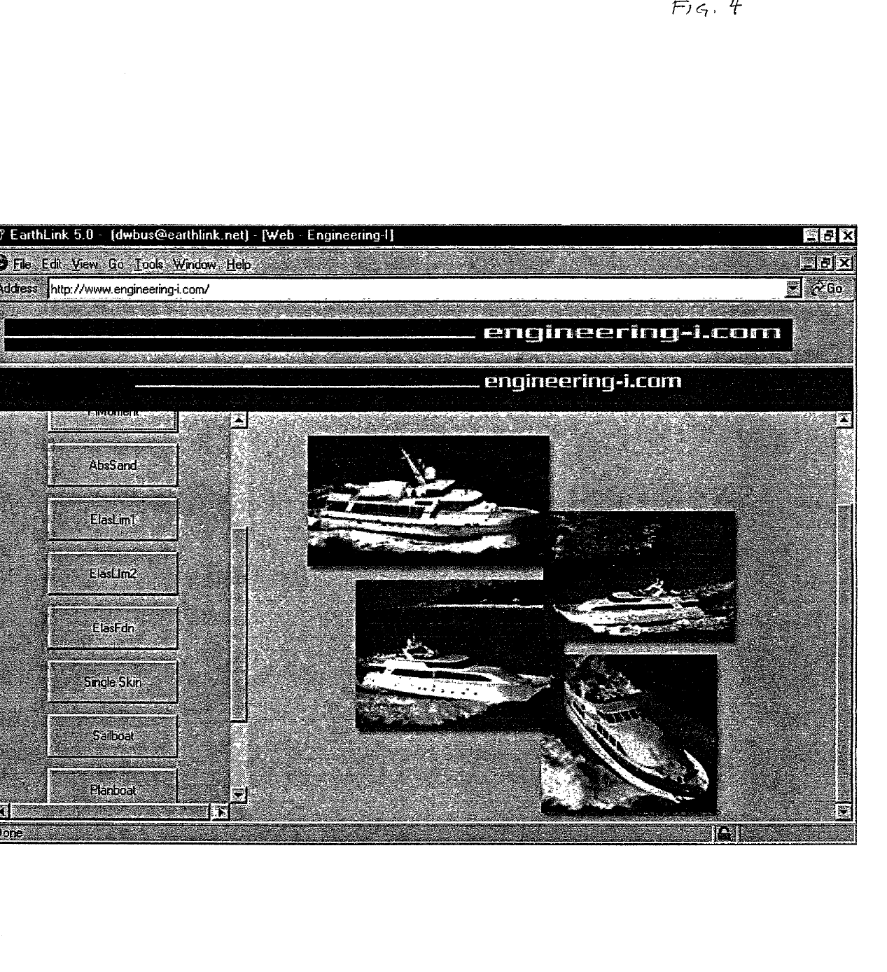

FIG. 1 illustrates a flowchart of the general steps performed by the user/customer at the website. The user level of interaction is set by the computer code. However, eSOLUTIONS can be accessed to provided information relating to basic, intermediate or advanced users. The user starts the desired calculation by choosing an input parameter at step 102. As seen in the Figures, the input parameter can be one of a variety of topics such as, but not limited to, panel location, core thickness, elastic line, length, elastic MOD top face, elastic MOD core, elastic MOD bottom face, top face thickness, bottom face thickness, x of BL/x, x of Load/x, etc. The user next chooses a measurement system at step 108, such as “SI”, English, etc. If necessary, the user prior to entering input data, can choose Selection Information at step 110, by preferably highlighting the selection at the eSOLUTIONS area of the webpage.

The eSOLUTIONS box preferably provides a text explanation of the Input parameter and explains the required input data at step 112. The user can also click on comparative examples, and can also receive information on the required input via streaming audio and/or streaming video, preferably to the right of the eSOLUTIONS box in the photo box. The input value is defined at step 118. Before entering the input value, the user can be provided with a text explanation of the input data, preferably within the eSOLUTIONS box. The user can click on the photo box or other area of the webpage to receive information on the input data preferably through streaming audio and/or streaming video at step 120. The results are calculated at step 126, preferably by clicking the “calculate” button on the webpage. Alternatively, the results can be automatically generated once all required input information has been entered by the user.

The calculation is performed by remote server and the results placed in the Output Data box on the webpage/screen at step 128. The user can choose to evaluate the output data at step 122. The eSOLUTIONS box preferably provides a text explanation of the output data and explains the comparative output data, structurally, dynamically and/or via graph(s) in the text box. The user can also click on the photo box at step 124 and receive information on the input or output data, preferably via streaming audio and/or streaming video. The user can also print the style sheet and/or save the output data file at step 130. Alternatively, and preferably in the advanced sections, an input file can be updated to the server, and the calculations completed as given from certain of the above steps.

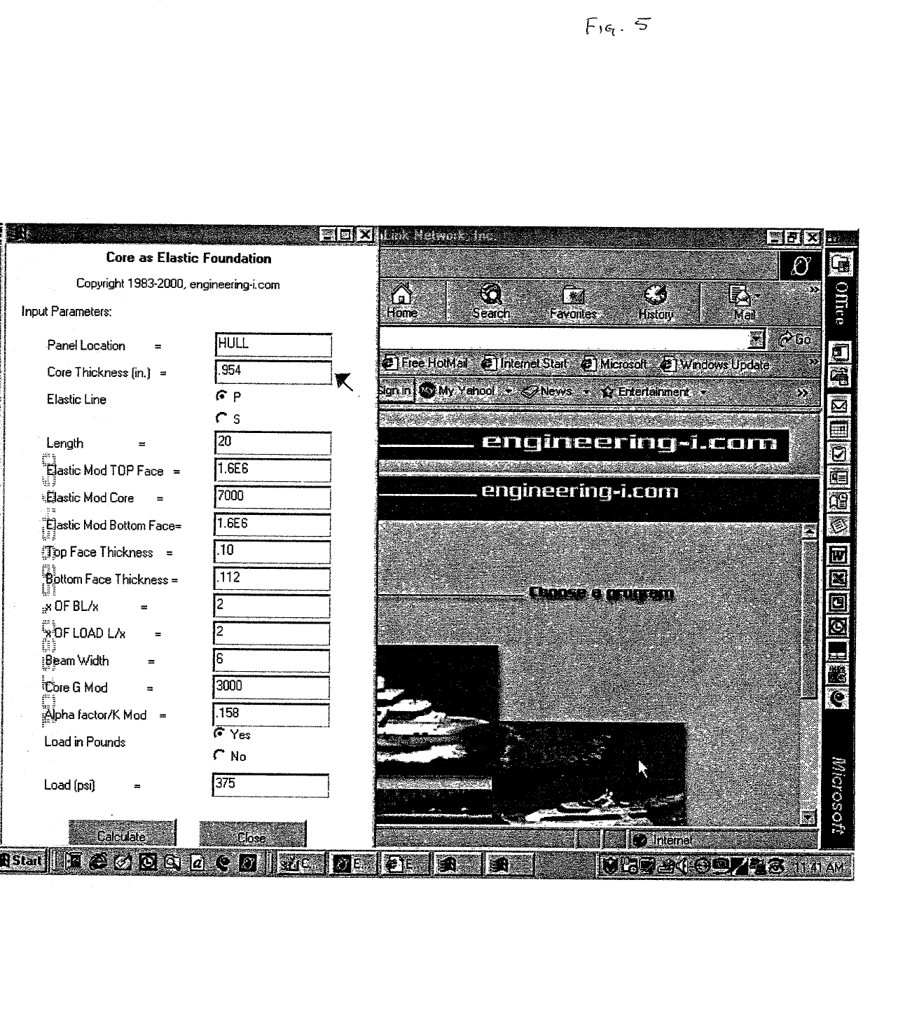

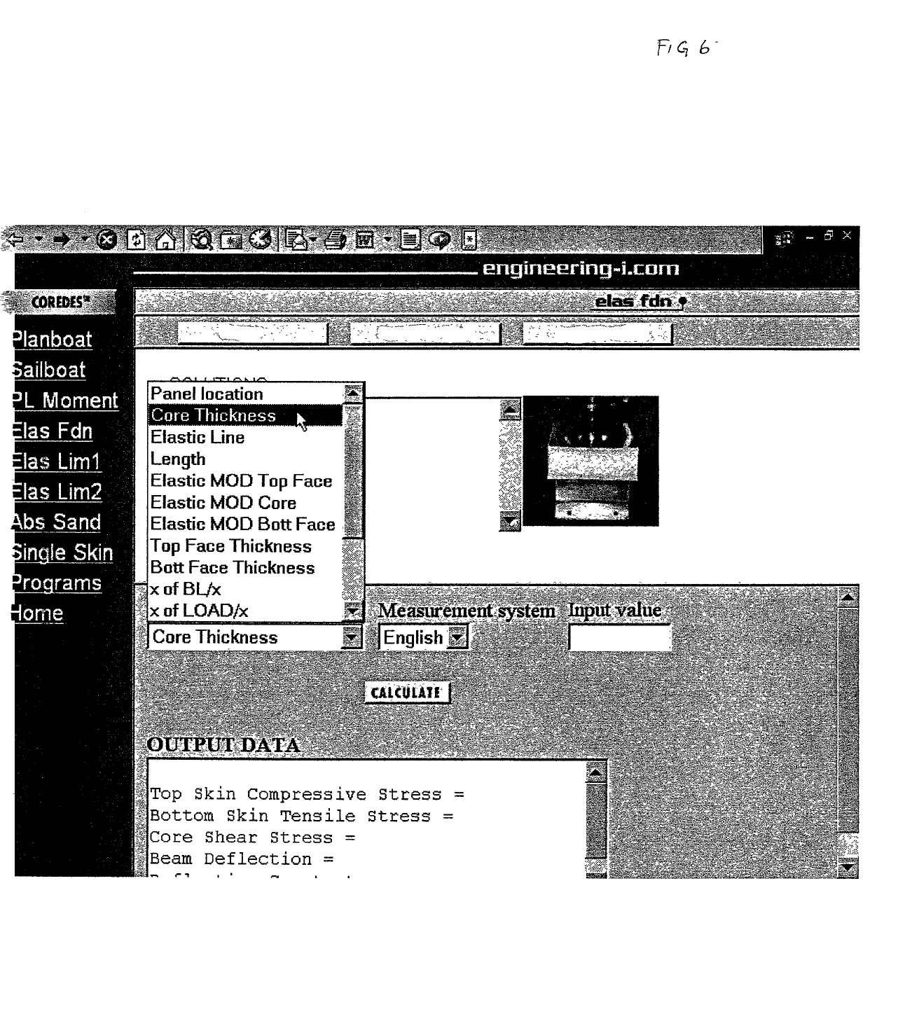

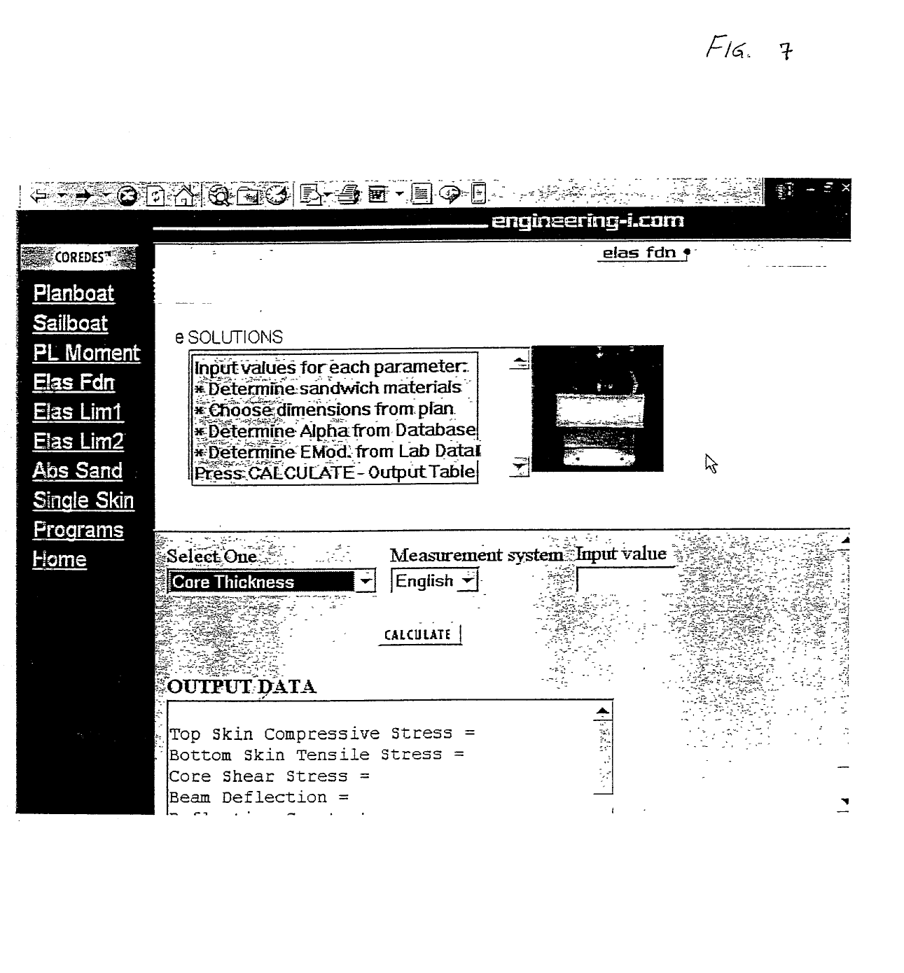

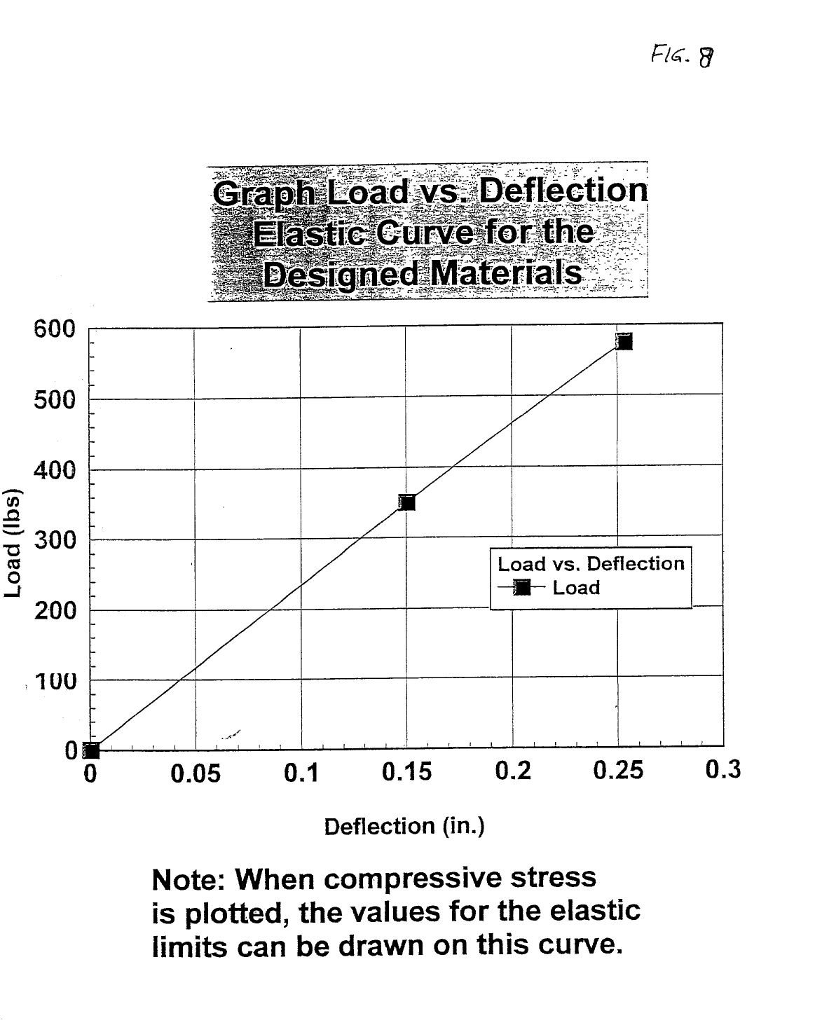

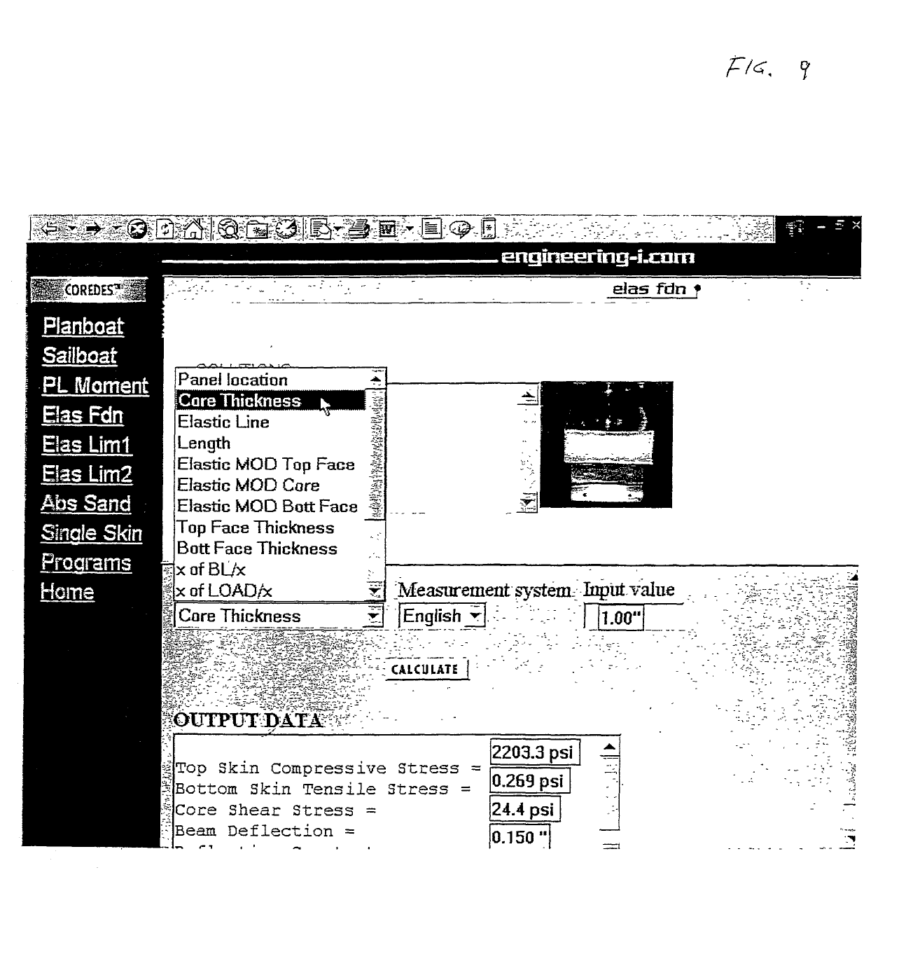

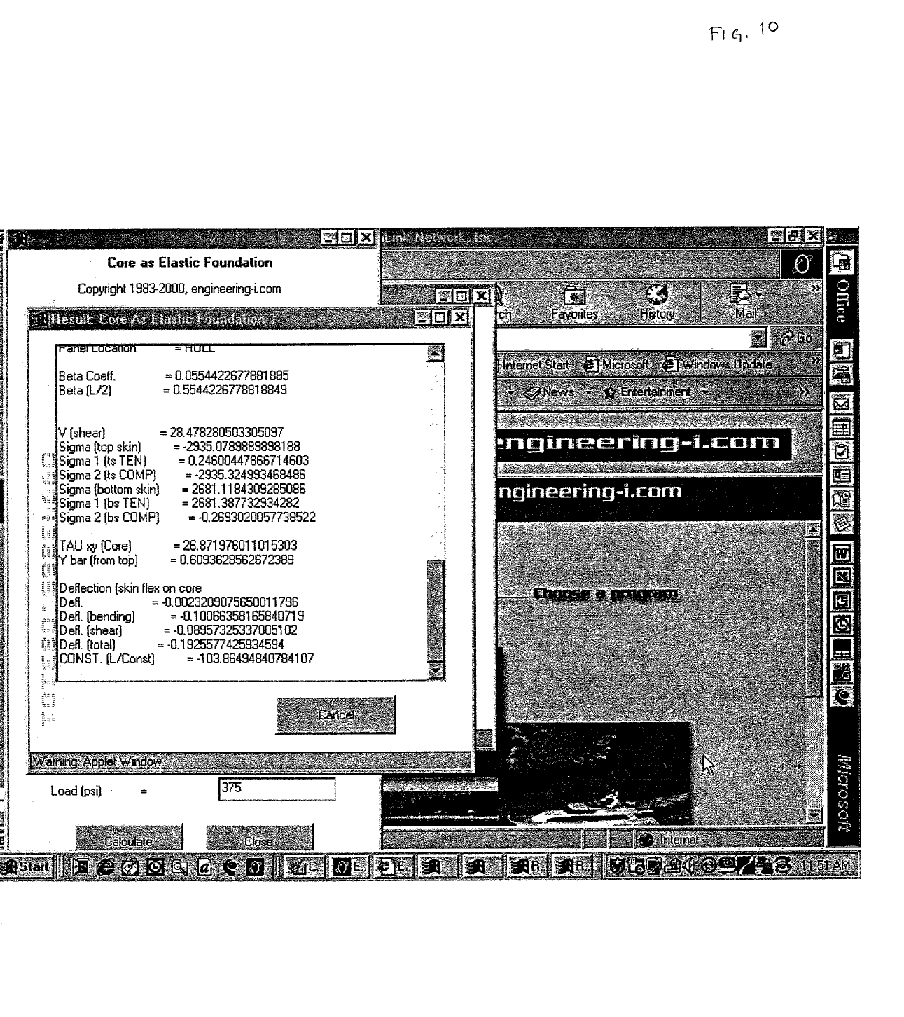

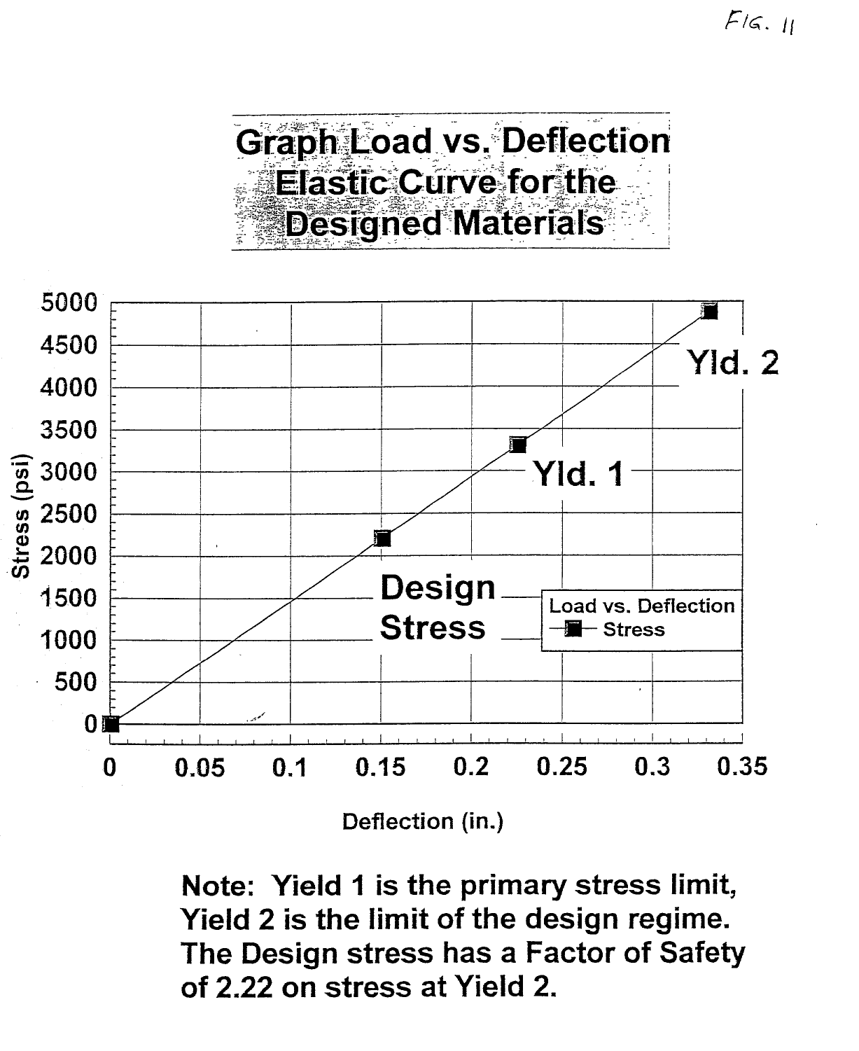

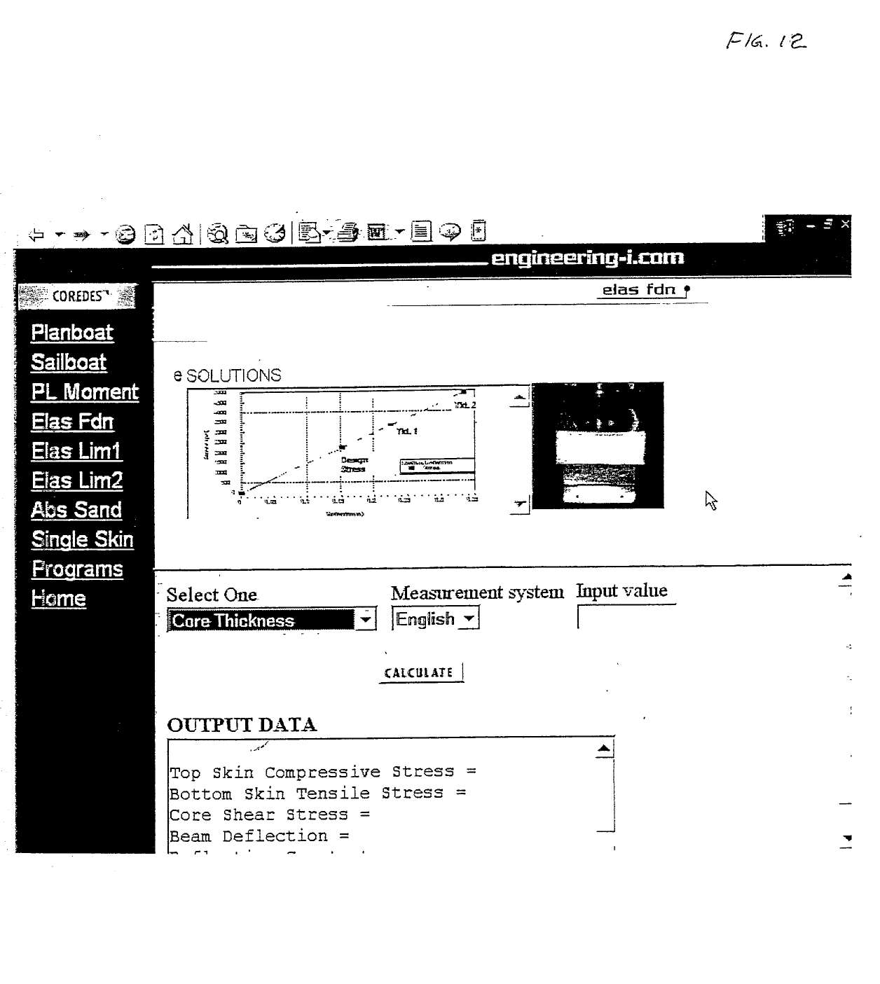

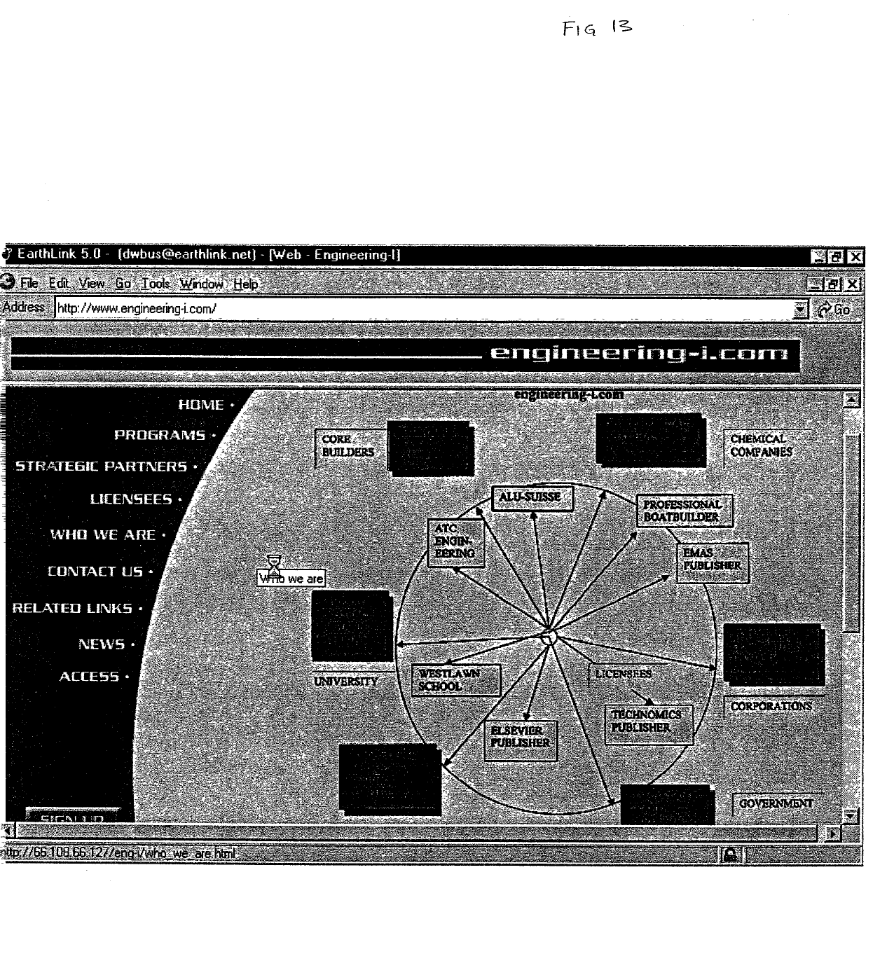

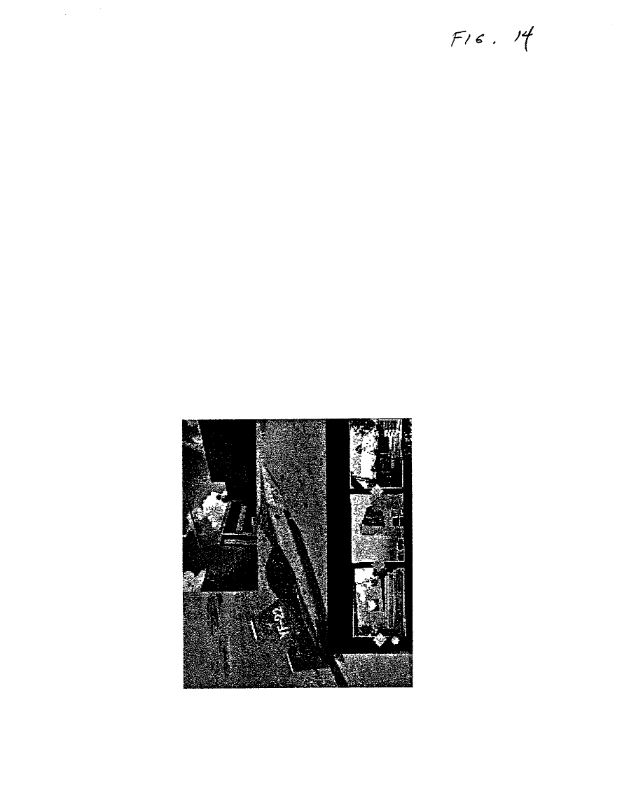

Substantively, the floating frame (white background with data lines) in FIG. 5 for INPUT data will also be floated on top of the eSOLUTIONS page as shown in FIG. 6. In this manner, the eSOLUTIONS text and picture frame can be made visible on the same page simply by moving the INPUT data frame around on the screen. Likewise, the data OUTPUT floating frame (white background with data lines) shown in FIG. 10 will also be floated on the eSOLUTIONS page shown in FIG. 9 for relatively large PC screens. For relatively very small screens (i.e. including, but not limited to, Pocket PC and PALM), access to the eSOLUTIONS text and drawings will be from FIGS. 5 and 10.

In all embodiments, the client's data is secure, as it does not reside on the server. All final computation results are preferably printed or downloaded to the user's own computer, which preserves the proprietary nature of the user's computations. The computational software resides solely with the provider of the services and is not accessible to the user. Thus, the present invention provides an engineering application service for the computation of a broad range of engineering data for various structures, including, but not limited to, composite and sandwich composite materials for structural analysis.

The present invention provides a unique engineering knowledge-base, which combines interactive capabilities of the Internet through the interface with the user, access to in-depth solutions for advance sandwich and composites technology. The present invention allows the user to have access to the methods of analysis and volumes of current information from scientific publishers, materials manufacturing companies, and sandwich core manufacturers available on the Internet, and access where they can control the input, have the output for the object (sandwich) construction database in-house, and retain the “know-how” to run the engineering application services within each company. Thus, the users are provided within a technical knowledge base in the atmosphere of a private workspace for worldwide communication.

The present invention, Internet knowledge-base, is also unique due to the interaction of its three major components:

1) the immediacy of the interactive Internet applications solutions, 2) the immediacy of access to sandwich solutions dynamic databases as part of the engineering programs site, and 3) immediate access to the latest technical papers, solutions and texts relevant to sandwich and other relevant technologies through links to the site. These three components of knowledge-base create an environment where the best mathematics solutions, updated data-base information, and immediate access to textual information contribute to a new and different process for creating all real-time engineering solutions.

The instant invention is not limited to any one type of engineering design. The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An online user interactive method for predicting a response of structures, such as sandwich composite structures and single skin composite components, said method comprising the steps of:
(a) selecting a parameter of a sandwich composite structure or single skin component for calculation;
(b) inputting values required for performing the calculation of the parameter;
(c) calculating a response for the parameter based on one or more stored formulas and the values inputted; and
(d) displaying the response.

2. The online user interactive method of claim 1 for including the step of selecting a measurement system for the parameter.

3. The online user interactive method of claim 1 further including the step of receiving information regarding the parameter prior to the step of inputting values.

4. The online user interactive method of claim 1 wherein step (d) comprises the step of displaying the response in a floating frame appearing on top of at least a portion of a website page appearing on a screen of the user.

5. The online user interactive method of claim 4 further including the displaying information regarding the response on the website page.

6. An online user interactive website for predicting responses of structures, such as sandwich composite structures and single skin composite components, said online user interactive website comprising:
means for allowing a user to select a parameter for calculating a response;
means for allowing the user to input values needed for performing the calculation of the parameter;
means for calculating a response for the parameter based on one or more stored formulas and the values inputted by the user; and
means for displaying the response.

7. The online user interactive website of claim 6 wherein the formulas are stored on a server remotely located from the user.

8. The online user interactive website of claim 6 wherein said means for allowing a user to select a parameter includes a website page appearing on a computer screen of the user which provides a list of parameters.

9. The online user interactive website of claim 6 wherein said means for allowing the user to input includes a floating frame disposed on top of at least a portion of a page of the website appearing on the user's screen.

10. The online user interactive website of claim 9 wherein the page is an eSOLUTIONS page.

11. The online user interactive website of claim 10 wherein said eSOLUTIONS page contains text regarding the parameter.

12. The online user interactive website of claim 10 wherein said eSOLUTIONS page contains one or more drawings regarding the parameter.

13. The online user interactive website of claim 10 wherein said eSOLUTIONS page contains text and one or more drawings regarding the parameter.

14. The online user interactive website of claim 6 further including streaming audio and streaming video regarding the parameter.

15. The online user interactive website of claim 6 further including an eSOLUTIONS page containing information regarding the parameter.

16. The online user interactive website of claim 15 wherein said eSOLUTIONS page, inputted values and displayed response appear on the same page appearing on a screen of the user.

17. The online user interactive website of claim 15 wherein said eSOLUTIONS page, inputted values and displayed response appear on a screen of the user such that they can be viewed all at the same time.

18. An online user interactive website for predicting responses of structures, such as sandwich composite structures and single skin composite components, said online user interactive website comprising:
means for allowing a user to select an input parameter for calculating a response;
an eSOLUTIONS page containing information regarding the parameter;
means for allowing the user to input values needed for performing the calculation of the input parameter, said means for allowing the user to input includes a floating frame disposed on top of at least a portion of said eSOLUTIONS page; and
means for calculating a response for the parameter based on one or more stored formulas and the values inputted by the user, said calculated response displayed within a second floating frame disposed on top of at least a portion of said eSOLUTIONS page.

19. The online user interactive website of claim 18 wherein the formulas are stored on a server remotely located from the user.

20. The online user interactive website of claim 18 further including streaming audio and streaming video regarding the parameter.
